(19) United States
(12) Patent Application Publication
(10) Pub. No.: US 2024/0204572 A1
(43) Pub. Date: Jun. 20, 2024

(54) MULTI-VEHICLE MOVING POWER BUS

(71) Applicant: International Business Machines Corporation, Armonk, NY (US)

(72) Inventors: Sarbajit K. RAKSHIT, Kolkata (IN); Sudhanshu Sekher SAR, Bangalore (IN); Sudheesh S. KAIRALI, Kozhikode (IN); Satyam JAKKULA, Bengaluru (IN)

(21) Appl. No.: 18/067,967

(22) Filed: Dec. 19, 2022

(51) Int. Cl. H02J 50/30

(52) U.S. Cl. CPC H02J 50/30

(57) ABSTRACT

Embodiments of the present disclosure provide an enhanced system and new techniques to implement a multi-vehicle moving power bus for supplying external power to autonomous target vehicles moving on the road. A multi-vehicle power bus controller forms a multi-vehicle moving power bus and controls a roadside laser power-beaming source connecting with autonomous vehicles in the moving power bus and supplying external power to the moving power bus. Any target autonomous vehicles in the moving power bus requiring additional power for battery charging are supplied with requested power from the multi-vehicle moving power bus connected to one or more roadside laser power-beaming sources.

### BACKGROUND

The present invention relates to wireless vehicle charging powering systems, and more specifically, to a system and methods for implementing a multi-vehicle moving power bus for supplying external power to autonomous target vehicles moving on the road.

While autonomous vehicles are running on the road, one or more autonomous vehicles may have a shortage of battery power and require additional power for battery charging. Current wireless systems are generally inadequate to reliably provide battery charging for moving vehicles. An enhanced system and new techniques are needed to enable reliable and effective power transfer for battery charging of moving vehicles requiring additional power, eliminating the time otherwise required for vehicles to stop to recharge the battery.

### SUMMARY

Embodiments of the present disclosure are directed to a system and methods for implementing a multi-vehicle moving power bus for supplying external power to autonomous target vehicles moving on the road. In a non-limiting method, a multi-vehicle power bus controller creates a multi-vehicle moving power bus and controls a roadside laser power-beaming source connecting with autonomous vehicles in the moving power bus and supplying external power to the moving power bus.

A non-limiting method is disclosed for implementing a multi-vehicle moving power bus to supply power to autonomous vehicles. An identified plurality of autonomous vehicles moving on a road form a multi-vehicle moving power bus to supply power from a laser power-beaming source to a moving target autonomous vehicle requiring power. The roadside laser power-beaming source connects with autonomous vehicles in the moving power bus, supplying external power to the moving power bus. The autonomous vehicles transfer power between each other in the power transfer bus. The target vehicle connected to the moving power bus receive requested power for battery charging. The disclosed method enables reliable, efficient effective utilization of external power supplied to the moving power bus.

Other disclosed embodiments include a computer system and computer program product for implementing a multi-vehicle moving power bus implementing features of the above-disclosed methods.

### BRIEF DESCRIPTION OF THE DRAWINGS

FIG. 1 is a block diagram of an example computer environment for use in conjunction with one or more disclosed embodiments for implementing a wireless multi-vehicle moving power bus;

FIG. 2 is a block diagram of an example system for implementing a wireless multi-vehicle moving power bus of one or more disclosed embodiments;

FIG. 3 is a schematic and block diagram illustrating example operations for implementing a wireless multi-vehicle moving power bus of one or more disclosed embodiments;

FIG. 4 is a schematic and block diagram illustrating further details of example operations for implementing a wireless multi-vehicle moving power bus one or more disclosed embodiments;

FIG. 5 is a flow chart illustrating example system operations of a method for implementing a wireless multi-vehicle moving power bus of one or more disclosed embodiments; and

FIG. 6 is a flow chart illustrating further example system operations of a method for implementing a wireless multi-vehicle moving power bus of one or more disclosed embodiments.

### DETAILED DESCRIPTION

Embodiments of the present disclosure implement a multi-vehicle moving power bus for supplying external power to target autonomous vehicles moving on the road. In a non-limiting method, a Multi-Vehicle Power Bus Controller forms a multi-vehicle moving power bus of multiple autonomous vehicles and controls a roadside laser power-beaming source supplying external power to autonomous vehicles in the moving power bus. Any target autonomous vehicles requiring power for battery charging are supplied with external power from the multi-vehicle moving power bus that can be connected to one or more roadside laser power-beaming sources. The multi-vehicle moving power bus comprises a continuous power transmission line created with participation of the multiple autonomous vehicles providing power transfer along with the length of the moving power bus and to any side of the moving power bus. The roadside laser power-beaming source comprises roadside infrastructure that can be a permanent or mobile installation of a power transmission module, for example, enabling a laser power-beaming transfer range of kilometers (kms) or equivalent to about 0.62 miles. The autonomous vehicles in the moving power bus transfer power with each other and dynamically collaborate with each other to change a length of the moving power bus with a required number of autonomous vehicles in the moving power bus. The target vehicles connected to the moving power bus receive requested power for battery charging.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

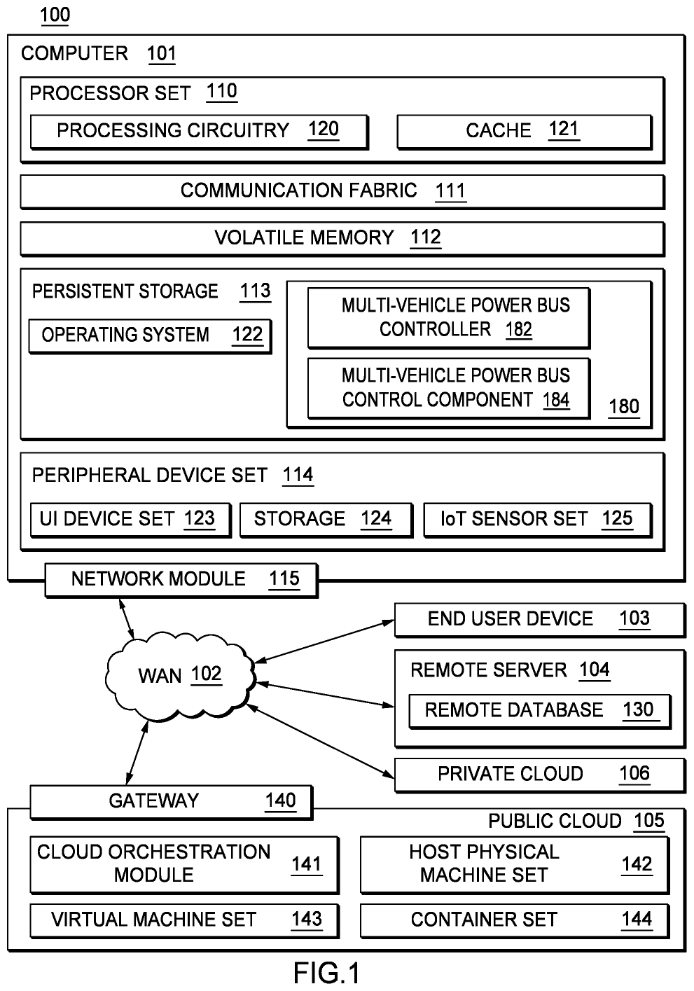

With reference now to FIG. 1, computing environment 100 contains an example of an environment for the execution of at least some of the computer code involved in performing the inventive methods, such as a Multi-Vehicle Power Bus Controller 182 and a Multi-Vehicle Power Bus Control Component 184 at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

An enhanced disclosed system and methods enable implementing a multi-vehicle moving power bus for supplying external power to autonomous target vehicles moving on the road. In a non-limiting method, a multi-vehicle power bus controller creates a multi-vehicle moving power bus and controls a roadside laser power-beaming source supplying external power and connecting with autonomous vehicles in the moving power bus. Any autonomous target vehicles requiring additional power for battery charging are supplied with external power from the multi-vehicle moving power bus that can be connected to one or more roadside laser power-beaming sources. The multi-vehicle moving power bus comprises a continuous power transmission line created with participation of multiple autonomous vehicles, providing power transfer along the length of the moving power bus and to any side of the power bus. The roadside laser power-beaming source comprises one or more roadside infrastructures, which can be a permanent or mobile installation of a power transmission module enabling a significant power transfer over a variable laser power-beaming transfer distance. In the moving power bus, the autonomous vehicles transfer power with each other and dynamically collaborate with each other to change a length of the moving power bus with an identified number of vehicles for the moving power bus to reliably transfer power to any vehicles requiring power for battery charging. The target vehicles connected to the moving power bus receive requested power for battery charging from the moving power bus.

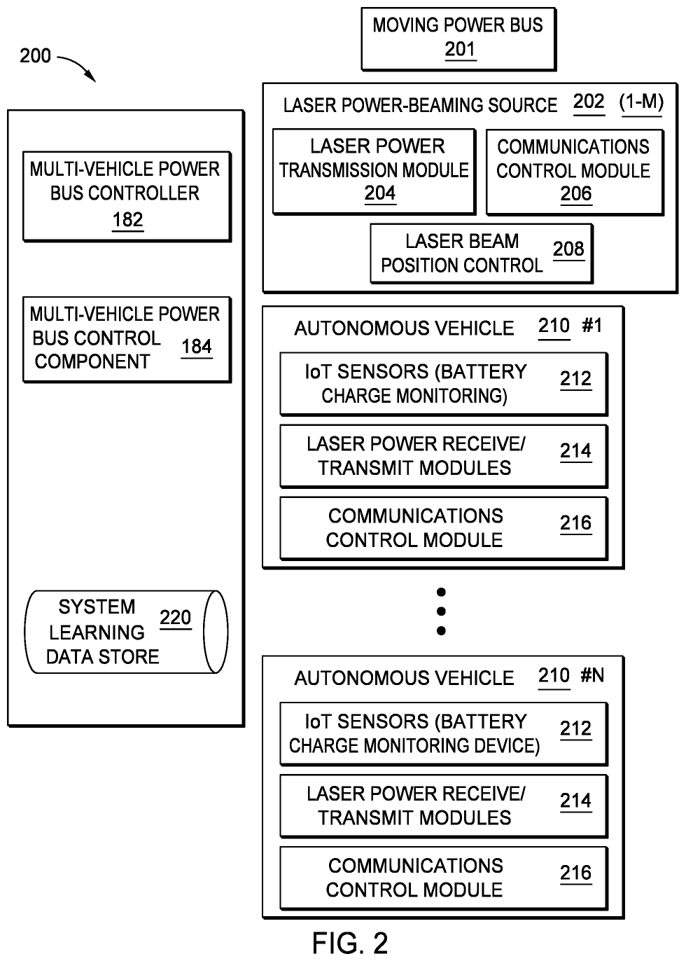

FIG. 2 illustrates an example system 200 for implementing a multi-vehicle moving power bus 201 of one or more disclosed embodiments. System 200 can be used in conjunction with the computer 101 and cloud environment of the computing environment 100 of FIG. 1 for implementing a multi-vehicle moving power bus of disclosed embodiments. System 200 includes the Multi-Vehicle Power Bus Controller 182 and the Multi-Vehicle Power Bus Control Component 184, for example used together with processor computer 101 of the computing environment 100 of FIG. 1 for implementing the multi-vehicle moving power bus 201 of disclosed embodiments.

System 200 includes one or more laser power-beaming sources 202, 1-M positioned roadside near multiple moving autonomous vehicles 210, 1-N forming a multi-vehicle moving power bus 201. Each laser power-beaming source 202 comprises a permanent or mobile roadside infrastructure of system 200. The roadside laser power-beaming source 202 supplies external power for battery charging of one or more autonomous target moving vehicles, where power is transferred by laser power-beaming of electromagnetic radiation, for example, with aligned and focused laser beams to the multi-vehicle moving power bus 201 of disclosed embodiments. A required number of the laser power-beaming sources 202, 1-M are installed roadside to ensure reliable and effective power transfer to multiple moving autonomous vehicles 210, 1-N forming the multi-vehicle moving power bus.

The laser power-beaming sources 202. 1-M can be implemented, for example using a PowerLight technology-based laser power transmission module. A length of the moving power bus 201 can dynamically be changed based on relative positions of the vehicles 210 requiring additional power and an associated laser power-beaming source 202.

Each laser power-beaming source 202 includes a laser power transmission module 204, for example enabling a laser power-beaming power transfer such as of one thousand watts over a range of kilometers (kms), (i.e., a transfer range of 0.62 mile or more.) Each laser power-beaming source 202 includes a communications control module 206. For example the communications control module 206 enables the Multi-Vehicle Power Bus Controller 182 of system 200 to identify any target moving autonomous vehicles 210 requiring power for battery charging and how much power is required, and identify a relative position of the target vehicles 210 requiring additional power. Each laser power-beaming source 202 includes a laser beam position control 208 to control the movement of the laser beam. For example, the roadside infrastructure laser power-beaming source 202 can be attached to pivotal joint that is operatively controlled for moving the laser beam relative to the moving power bus.

Dynamically aligning the laser beam focus of the laser power transmission module 204 with the multi-vehicle moving power bus 201 efficiently creates a power transmission line through the moving autonomous vehicles 210, 1-N forming the moving power bus. As a result, the target autonomous vehicles 210 can seamlessly receive power from the moving power bus 201 for battery charging.

In one embodiment, each of multiple moving autonomous vehicles 210, 1-N includes Internet of Things (IoT) sensors 212, for example, one IoT sensor may monitor battery charge level or status of the vehicle. Each autonomous vehicle 210 includes one or more laser power receive/transmit modules 214, enabling the vehicle 210 to receive laser beam power for battery charging when needed and to transmit laser beam power to another vehicle in the moving power bus 201. In one embodiment, each autonomous vehicle 210 includes a communications control module 216 enabling communications with the Multi-Vehicle Power Bus Controller 182, between multiple autonomous vehicles 210, and the laser power-beaming sources 202.

The system 200 includes a system historical learning data store 220 that can store for example system parameter and operational data provided by the Multi-Vehicle Power bus Controller 182. System historical learning data store 220 stores, for example, an aggregated amount of power required by the multiple moving autonomous vehicles 210, 1-N, position and specifications of the laser power-beaming sources 202, associated road profile, and the like. The Multi-Vehicle Power bus Controller 182 can analyze stored system parameter and operational data based upon current and historical learning to identify a number and location for installing additional laser power-beaming sources 202. The Multi-Vehicle Power bus Controller 182 can determine a number and location of additional mobile laser power-beaming sources 202 to be deployed based on predicted power requirements.

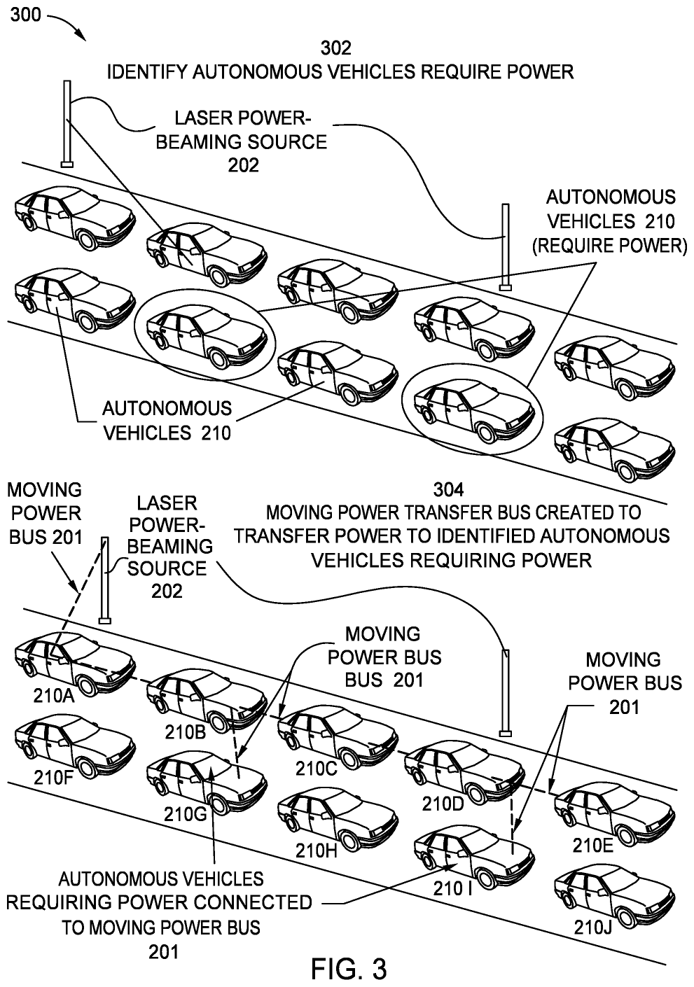

FIG. 3 illustrates example functional operations 300 implementing a multi-vehicle moving power bus 201 of one or more disclosed embodiments. In FIG. 3, the illustrated example operations 300 include an operation 302 to identify one or more autonomous vehicles that require power for battery charging. As shown, a pair of laser power-beaming sources 202 provided roadside near a plurality of autonomous vehicles 210 A-J including autonomous vehicles 210 G and 210 I that require power. In an operation 304, a moving power transfer bus 201 is formed by the laser power-beaming sources 202 and illustrated autonomous vehicles 210 A-E and can include the two identified autonomous vehicles 210 G and 210 I requiring power. The moving power transfer bus 201 transfers power to the identified autonomous vehicles 210 G and 210 I requiring power. As shown, the illustrated moving power transfer bus 201 includes five autonomous vehicles 210 A-E that do not require charging. As shown, each of the autonomous vehicles 210 A-D transfers power forward to another vehicle in the same lane and can also use received power to charge its own battery. The respective autonomous vehicles 210 B and D transfer power to their side to a different lane for the two identified autonomous vehicles 210 G and I requiring power. In general the laser power-beaming sources 202 supplies to the moving power bus 201 where some vehicles 210 can use received power to charge its own battery. In contrast, other vehicles 210 in the power bus 201 such as the illustrated autonomous vehicles 210 A-E may not use the received power to charges its battery.

For example, a vehicle 210 moving on the road is out of range and needs charging. The Multi-Vehicle Power bus Controller 182 of system 200 determines that it will take three cars to form a power bus of sufficient length to reach the target vehicle with a nearby laser power-beaming source 202. Later, as the target vehicle 210 requiring power continues to move, the target vehicle (which still needs to be charged) is another mile down the road. The Multi-Vehicle Power bus Controller 182 determines it needs to add two new vehicles 210 to the power bus 201 because the other three vehicles are also now an additional mile down the road.

Even later, the target vehicle 210 is now closer to another laser power-beaming source 202 that is further down the road from the vehicle (though still out of range). The Multi-Vehicle Power bus Controller 182 can instead choose two different vehicles 210 that are between the target vehicle and the other (second) source 202 to form a different (second) moving power bus 201 to reach the source. The other power bus 201 to the first source 202 that was behind the target vehicle 210 can be deactivated. The second moving power bus 201 transfers power to the target vehicle, reliably charging its battery.

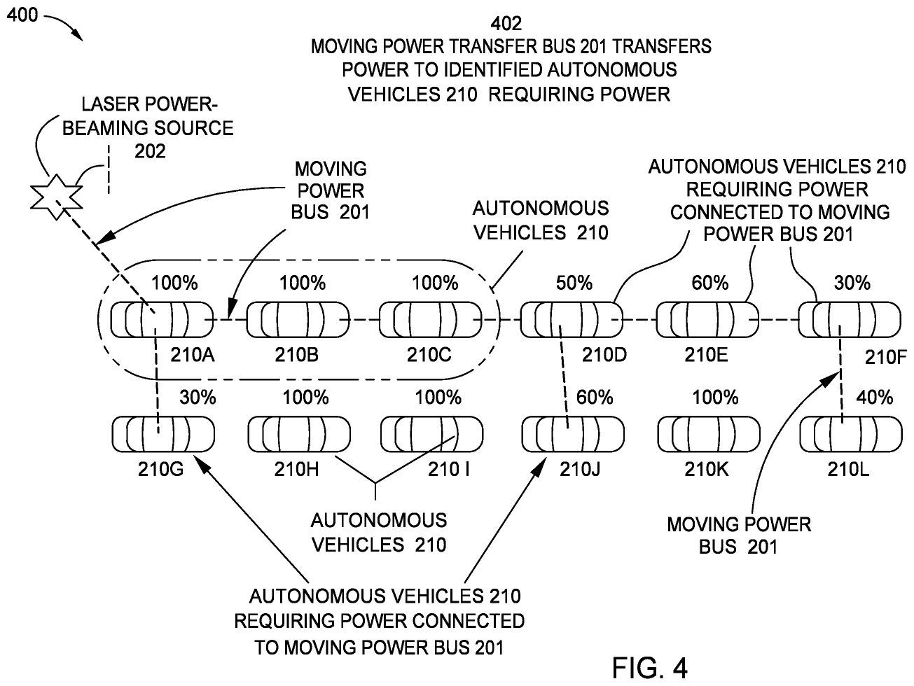

In FIG. 4, illustrated example operations 400 can implement a multi-vehicle moving power bus 201 of one or more disclosed embodiments. As shown, in an operation 402 the moving power transfer bus 201 transfers power to the identified autonomous vehicles 210 requiring power. Each of the autonomous vehicles 210 requiring power are connected to the moving power bus 201. In one embodiment, the multi-vehicle moving power bus 201 is a continuous power transmission line created with laser power-beaming source 202 and participation of the illustrated multiple autonomous vehicles 210 providing power transfer along with the length of the moving power bus and to one side of the moving power bus. As shown, the moving power bus 201 extends from the illustrated roadside laser power-beaming source 202 through multiple (three) autonomous vehicles 210 A, B. and C not requiring power and through multiple (three) autonomous vehicles 210 D, E, and F requiring power in a first lane and to three identified autonomous vehicles 210 G. J, and L requiring power in a second lane. An example percentage charge level of the vehicle's battery is shown above each of the illustrated autonomous vehicles 210. As shown, the identified three autonomous vehicles 210 D, E, and F requiring power in the first lane have a respective percentage charge level of 50%, 60%, and 30%. In the second lane the identified two autonomous vehicles 210 G, J, and L requiring power have a respective percentage charge level of 30%, and 60%, with each receiving required power from the moving power bus 201 for effective battery charging.

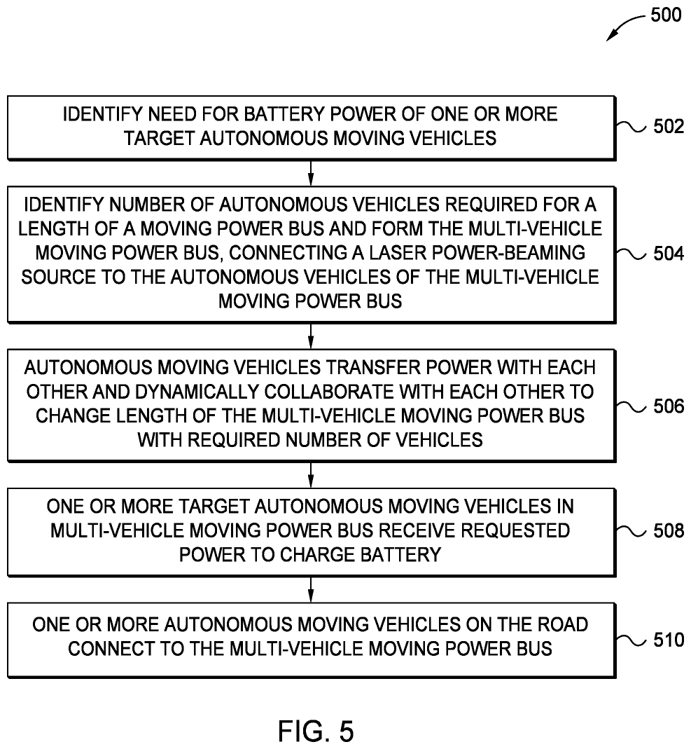

FIG. 5 illustrates example operations of a non-limiting method 500 for implementing the moving power transfer bus 201 of one or more disclosed embodiments. Method 500 can be implemented with the Multi-Vehicle Power Bus Controller 182 and the Multi-Vehicle Power Bus Control Component 184, for example used together with processor computer 101. As indicated at block 502, the Multi-Vehicle Power Bus Controller 182 identifies a need for power of one or more moving target autonomous vehicles 210 requiring power. In one embodiment, the Multi-Vehicle Power Bus Controller 182 determines the moving target autonomous vehicles 210 requiring power is out-of-sight or out-of-range of the laser power-beaming source 202, and thus, the target vehicle cannot receive power directly from the laser power-beaming source 202. At block 504, the Multi-Vehicle Power Bus Controller 182 identifies a number of autonomous vehicles 210 for a selected length of the moving power bus and forms the moving power transfer bus 201 using the laser power-beaming source 202 and identified autonomous vehicles 210. For example, the length of the moving power bus is determined based on the relative position of the laser power-beaming source 202 and the identified autonomous vehicles 210 of the moving power bus 201 including the target autonomous vehicles 210 requiring power.

At block 506, the autonomous vehicles 210 of the moving power transfer bus 201 collaborate with each other, that is the autonomous vehicles 210 receive and transfer between each other and communicate vehicle and power bus status with the Multi-Vehicle Power Bus Controller 182. The autonomous vehicles 210 of the moving power transfer bus 201 can dynamically increase the length of the moving power bus 201 with more vehicles 210 added to receive and transfer power in the power bus so that a required number of autonomous vehicles 210 is provided. For example, the length of the moving power bus 201 can be changed dynamically based on relative position of the laser power-beaming source 202 supplying power to the moving power bus and the target vehicles requiring power. For example, if the autonomous vehicles 210 of the moving power bus 201 move out of range of the associated laser power-beaming source 202 the length of the moving power bus 201 should increase to enable charging a battery of the target vehicles requiring power. Also when the battery of one or more target vehicles requiring power is fully charged, the length of the moving power bus 201 can be decreased accordingly, or deactivated when battery charging is not requested by any vehicle.

The length of the moving power bus 201 is selected to reliably supply power from the laser power-beaming source 202 to the moving power bus 201 to enable reliable power transfer from the moving power bus 201 to the target autonomous vehicle requiring power. The Multi-Vehicle Power Bus Controller 182 can change the length of the moving power bus 201 on the road to ensure each autonomous vehicle can receive requested power in a seamless manner from the moving power bus.

As indicated at block 508, one or more target autonomous vehicles 210 requiring power in the moving power bus on the road receive requested power and recharge the battery for the target autonomous vehicles. At block 510, one or more autonomous vehicles 210 can connect and be added to the moving power bus on the road to transmit and receive power, at any time during the operation of the moving power bus. For example, one or more autonomous vehicles 210 requiring power can connect to the moving power bus and receive requested power from the moving power bus for charging a battery of each of the autonomous vehicles requiring power For example, the autonomous vehicles 210 can dynamically connect to the moving power bus to change the length of the moving power bus. Without autonomous vehicles requiring power, the moving power bus can be deactivated.

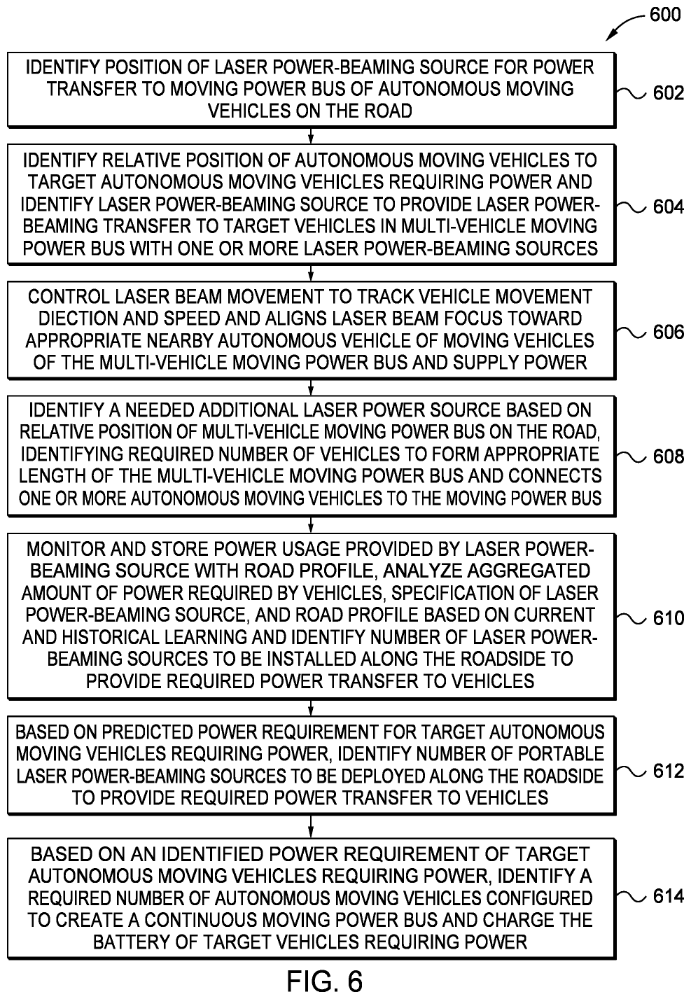

FIG. 6 illustrates further example operations of the moving power transfer bus 201 of a non-limiting method 600. Method 600 can be implemented with the Multi-Vehicle Power Bus Controller 182 and the Multi-Vehicle Power Bus Control Component 184, for example used together with processor computer 101.

As indicated at block 602, the Multi-Vehicle Power Bus Controller 182 identifies the position of the laser power-beaming source 202 for power transfer to multiple autonomous vehicles 210 of the moving power bus. As indicated at block 604, the Multi-Vehicle Power Bus Controller 182 identifies the relative position of multiple autonomous vehicles 210 to each target autonomous vehicle 210 requiring power and identifies the laser power-beaming source 202 to provide laser power-beaming transfer to the target autonomous vehicles 210 requiring power. One or more laser power-beaming sources 202 of system 200 can transfer power to the moving power bus.

As indicated at block 606, the Multi-Vehicle Power Bus Controller 182 can control the laser beam movement of the laser power-beaming source 202, for example the Multi-Vehicle Power Bus Controller 182 tracks vehicle movement direction and speed, and aligns the laser beam focus of the laser power-beaming source toward an appropriate nearby autonomous vehicle of multiple autonomous vehicles 210 of the moving power bus. At block 608, the Multi-Vehicle Power Bus Controller 182 identifies if an additional external laser power-beaming source 202 is needed, and based on the position of the laser power-beaming source 202, the Multi-Vehicle Power Bus Controller 182 identifies a number of autonomous vehicles 210 required to form an appropriate length of the moving power bus. At block 608 at any time during operation of the moving power bus, the Multi-Vehicle Power Bus Controller 182 can enable additional autonomous vehicles 210 to connect the moving power bus.

As indicated at block 610, during operation of the moving power bus, the Multi-Vehicle Power Bus Controller 182 monitors and stores power usage provided by the laser power-beaming sources 202. At block 610, the Multi-Vehicle Power Bus Controller 182 can analyze system operations data based on current and historical learning. The system operations data can include for example, an aggregated amount of power required by the vehicles, a specification of the laser power-beaming source 202, a road profile and the like. At block 610, the Multi-Vehicle Power Bus Controller 182 can identify based on this analysis, a number of laser power-beaming sources 202 to be installed along the roadside to ensure required power transfer to the autonomous vehicles 210. At block 612, for example based on a predicted power requirement, the Multi-Vehicle Power Bus Controller 182 can identify a number of portable laser power-beaming sources 202 to be deployed along the roadside to provide required power transfer to the autonomous vehicles 210. At block 614, for example based on identified power requirement for the autonomous vehicles 210, the Multi-Vehicle Power Bus Controller 182 can identify a required number of autonomous vehicles configured to create a continuous moving power bus on the road and charge the battery of the target vehicles requiring power.

While the foregoing is directed to embodiments of the present invention, other and further embodiments of the invention may be devised without departing from the basic scope thereof, and the scope thereof is determined by the claims that follow.

What is claimed is:

1. A method comprising:
identifying a plurality of autonomous vehicles moving on a road to use as a multi-vehicle moving power bus to supply power from a laser power-beaming source to a moving target autonomous vehicle requiring power;
supplying external power to the moving power bus with the laser power-beaming source;
transferring laser power between the plurality of moving autonomous vehicles in the moving power bus; and
charging a battery of the target autonomous vehicle requiring power with the moving power bus.

2. The method of claim 1, further comprising:
dynamically identifying a number of autonomous vehicles moving on a road required for the moving power bus; and
connecting one or more autonomous vehicles to the moving power bus on the road.

3. The method of claim 1, wherein identifying the plurality of autonomous vehicles for use as a multi-vehicle moving power bus is based on relative positions of the plurality of autonomous vehicles moving on a road and the moving target autonomous vehicle requiring power.

4. The method of claim 1, wherein supplying external power to the moving power bus with the laser power-beaming source comprises identifying power required for battery charging of the target autonomous vehicle requiring power and connecting one or more roadside laser power-beaming sources to the moving power bus.

5. The method of claim 1, wherein supplying external power to the moving power bus with the laser power-beaming source comprises providing the laser power-beaming source at a roadside location relative to the plurality of autonomous vehicles moving on a road.

6. The method of claim 1, wherein supplying external power to the moving power bus with the laser power-beaming source comprises dynamically controlling the laser power-beaming source to align a laser beam focus toward the moving power bus.

7. The method of claim 1, wherein transferring laser beam power between the plurality of moving autonomous vehicles in the moving power bus comprises selectively transmitting laser beam power from one moving autonomous vehicle to another moving autonomous vehicle along a length of the moving power bus and along a side of the moving power bus.

8. The method of claim 1, wherein transferring laser beam power between the plurality of moving autonomous vehicles in the moving power bus comprises tracking movement direction and speed of the plurality of moving autonomous vehicles in the moving power bus, and identifying another laser power-beaming source for supplying external power to the moving power bus.

9. The method of claim 1, wherein transferring laser beam power between the plurality of moving autonomous vehicles in the moving power bus comprises dynamically changing a length of the moving power bus based on a relative position of the target autonomous vehicle requiring power.

10. The method of claim 1, wherein supplying external power to the moving power bus with the laser power-beaming source comprises identifying a required number of the laser power-beaming sources to be provided roadside of the moving power bus based on analyzing a power requirement for the target autonomous vehicle requiring power.

11. A system, comprising:
a processor; and
a memory, wherein the memory includes a computer program product configured to perform operations for implementing a multi-vehicle moving power bus for supplying external power to autonomous vehicles moving on a road, the operations comprising:
identifying a plurality of autonomous vehicles moving on a road to use as a multi-vehicle moving power bus to supply power from a laser power-beaming source to a moving target autonomous vehicle requiring power;
supplying external power to the moving power bus with the laser power-beaming source;
transferring laser power between the plurality of moving autonomous vehicles in the moving power bus; and
charging a battery of the target autonomous vehicle requiring power with the moving power bus.

12. The system of claim 11, further comprising:
dynamically identifying a number of autonomous vehicles moving on a road required for the moving power bus; and
connecting one or more autonomous vehicles to the moving power bus on the road.

13. The system of claim 11, wherein supplying external power to the moving power bus with the laser power-beaming source comprises providing the laser power-beaming source at a roadside location relative to the plurality of autonomous vehicles moving on a road.

14. The system of claim 11, wherein supplying external power to the moving power bus with the laser power-beaming source comprises dynamically controlling the laser power-beaming source to align a laser beam focus toward the moving power bus.

15. The system of claim 11, wherein transferring laser beam power between the plurality of moving autonomous vehicles in the moving power bus comprises selectively transmitting laser beam power from one moving autonomous vehicle to another moving autonomous vehicle along a length of the moving power bus and along a side of the moving power bus.

16. A computer program product for implementing a multi-vehicle moving power bus for supplying external power to autonomous vehicles moving on a road, the computer program product comprising:
a computer-readable storage medium having computer-readable program code embodied therewith, the computer-readable program code executable by one or more computer processors to perform an operation comprising:
identifying a plurality of autonomous vehicles moving on a road to use as a multi-vehicle moving power bus to supply power from a laser power-beaming source to a moving target autonomous vehicle requiring power;
supplying external power to the moving power bus with the laser power-beaming source;
transferring laser power between the plurality of moving autonomous vehicles in the moving power bus; and
charging a battery of the target autonomous vehicle requiring power with the moving power bus.

17. The computer program product of claim 16, further comprises
dynamically identifying a number of autonomous vehicles moving on a road required for the moving power bus; and
connecting one or more autonomous vehicles to the moving power bus on the road.

18. The computer program product of claim 16, wherein supplying external power to the moving power bus with the laser power-beaming source comprises providing the laser power-beaming source at a roadside location relative to the plurality of autonomous vehicles moving on a road.

19. The computer program product of claim 16, wherein supplying external power to the moving power bus with the laser power-beaming source comprises dynamically controlling the laser power-beaming source to align a laser beam focus toward the moving power bus.

20. The computer program product of claim 16, wherein transferring laser beam power between the plurality of moving autonomous vehicles in the moving power bus comprises selectively transmitting laser beam power from one moving autonomous vehicle to another moving autonomous vehicle along a length of the moving power bus and along a side of the moving power bus.
